(19) United States
(12) Patent Application Publication
(10) Pub. No.: US 2006/0204780 A1
(43) Pub. Date: Sep. 14, 2006

(54) Development of low gloss coated surfaces on vehicle wheels

(76) Inventors: Luis Fanor Vega, Cheswick, PA (US); Thomas L. Levendusky, Greensburg, PA (US); Albert L. Askin, Lower Burrell, PA (US); Kevin M. Robare, New Kensington, PA (US); Robert E. Bombalski, Pittsburgh, PA (US)

Correspondence Address: INTELLECTUAL PROPERTY, ALCOA TECHNICAL CENTER, BUILDING C, 100 TECHNICAL DRIVE, ALCOA CENTER, PA, 15069-0001, US

(21) Appl. No.: 11/080,798

(22) Filed: Mar. 14, 2005

(51) Int. Cl. B23P 9/00

(52) U.S. Cl. 428/687; 428/141

(57) ABSTRACT

A process for lowering the gloss of a coated aluminum wheel surface is disclosed. The process comprises applying a roughening agent to the coated aluminum wheel surface via an application means. The roughening agent comprises grit powder, preferably iron or alumina grit, or plastic media and the application means comprises blasting, spraying, or painting. The invention lowers the gloss of the coating without reducing its overall performance. A wheel having a coated surface with a low gloss and a low gloss coating are also disclosed.

### FIELD OF THE INVENTION

The present invention relates to coatings that are applied to the surface of articles, specifically aluminum wheels, to protect the polished or satin machine finish on the wheel surface. More specifically, the invention relates to lowering the surface luster of the coating without negatively impacting its protective aspects.

### BACKGROUND OF THE INVENTION

Coatings, such as powder and paint coatings, are currently applied to aluminum wheels to protect the polished or satin machine finish on the wheel surface. These coatings are normally clear and have a high gloss or surface luster, usually greater than 80% as measured with a 60 degree gloss meter. A gloss meter measures the specular reflection, which is merely the degree of the angle of reflection of a light source on a surface. Different angles, or geometries, are better for measuring different gloss values and surfaces. For example, if you are measuring low gloss surfaces (0 to 30 gloss units) the 85 degree meter is preferred. If you are measuring semi-gloss surfaces (30 to 70 gloss units) the 60 degree meter is preferred. And for high gloss surfaces (over 70 gloss units) the 20 degree meter is preferred. In practice, some prefer to specify the degree of gloss as percentage of full gloss. Therefore, 80% gloss is the same as 80 degrees gloss. In the case of non-metals (coatings, plastics), the amount of reflected light increases with the increase of the illumination angle or the angle at which the light source is pointed toward the material. The remaining illuminated light penetrates the material and is absorbed or diffusely scattered depending on the color. Metals have a much higher reflection and are less dependent on the illumination angle than non-metals.

When a low gloss finish is needed, usually less than 30% as measured with the same degree gloss meter, this represents a formulation problem for the coating suppliers. One of the main drawbacks is that the matting or flattening agents added to the coating reduces the ability of the coating to resist degradation due to mechanical wear by hard and rough objects. Matting or flattening agents are groups of additives for coatings that reduce their gloss. Precipitated silica (silica gel) and fumed silica are types of matting agents that are commercially available for decorative and industrial paints. In addition, the current clear, high gloss coatings have ultra violet light radiation resistance and optical clarity for current product requirements. Enhancements to UV resistance require the addition of blockers and stabilizers. These additives are aimed at enhancing coating durability toward destructive factors of service conditions and protecting coating film and substrate from chemical and structural changes and associated loss of coating serviceability. While these additives are also beneficial to lowering gloss, they negatively affect the optical clarity of the coating.

There remains a need for a process that would take advantage of the protective aspects of the existing coating, but would yield a surface gloss that is lower than currently available.

The primary object of the present invention is to provide a process that lowers the gloss level of a coated aluminum wheel surface, yet does not negatively impact the protective aspects of the coating.

This and other objects and advantages are met or exceeded by the instant invention, and will become more fully understood and appreciated with reference to the following description.

### SUMMARY OF THE INVENTION

The invention relates to a process for lowering the gloss of a coated aluminum wheel surface. The process comprises applying a roughening agent to the coated aluminum wheel surface via an application means. The roughening agent comprises iron powder, alumina powder, or plastic media and the application means comprises blasting, spraying, or painting. Unlike chemical modification of the coating through the use of a chemical agent, such as matting and flattening agents or blockers and stabilizers, it is believed that physical modification through the use of the claimed process contained herein does not negatively impact the protective aspects of the coating. Lowering the gloss of the coating while not reducing its overall performance is important to the success of automobile wheel manufacturers that require the wheel to have less surface luster.

### BRIEF DESCRIPTION OF THE DRAWINGS

The patent or application file contains at least one drawing executed in color. Copies of this patent or patent application publication with color drawing(s) will be provided by the office upon request and payment of the necessary fee.

FIG. 1 shows the process of the present invention.

FIG. 2 shows a vehicle wheel having a surface with a high gloss coating.

FIG. 3 shows a vehicle wheel surface that has been subjected to the process of the present invention.

### DETAILED DESCRIPTION OF PREFERRED EMBODIMENTS

The invention relates to a process for lowering the gloss of a coated aluminum wheel surface. The process comprises applying a roughening agent to the coated wheel surface via an application means. It is believed that lowering the gloss of the coating via the application of a roughening agent on the wheel surface maintains the protective aspects of the coating.

In this specification, the wheel surface means a surface which faces outward from a vehicle body and forms a part of the overall appearance of a vehicle. The wheel is preferably made of aluminum and is obtained by pouring a molten aluminum alloy into a mold having a predetermined shape. The wheel is taken out of the mold and subjected to a process of shot peening. Usually, this process involves steel balls or steel wire chips, having a diameter of about 0.8 to about 1.2 mm, being air sprayed under pressure equivalent to about 5.2-6.0 kg/cm² at a speed of not less than about 80 m/sec. Although shot peening is performed all over the vehicle wheel for about 20 minutes under such conditions, shot peening on the portion of the outside surface of the vehicle wheel is performed particularly carefully since a transparent coating is to be formed on the surface.

Shot peening is a process having a comparatively high degree of freedom, so that it is possible to spray shots almost uniformly all over the curved surface to thereby form a plastic deformation layer uniformly.

The surface of the vehicle wheel subjected to such shot peening becomes a minute matte-finished rough surface, and a plastic deformation layer is formed in its superficial portion. Since this plastic deformation layer is formed by the impact of shots, the plastic deformation layer opens to the surface of the vehicle wheel, so that holes or cracks such as bubbles containing air or moisture therein disappear by being compressed in the plastic deformation layer, and air contained in such holes, water used in the working of casting the vehicle wheel, and so on, are exhausted outside.

The plastic deformation layer formed in the superficial portion of the surface is substantially free of air or moisture. Even if preliminary finishing or mirror finishing is performed by wet buffing, moisture will not remain in the superficial portion of the surface so as to become a hindrance to the formation of the transparent coating.

Shot peening can be performed under any condition including those mentioned above.

Further, since shot peening involves spraying shots to impact the surface of the vehicle wheel, it is possible to remove and eliminate mill scale, adhering foreign matters, and dirt or the like from the surface of the vehicle wheel blank thereby making the surface clean.

Next, the wheel is machined so as to be formed into a predetermined accurate shape as the vehicle wheel.

The surface of the vehicle wheel is then subjected to various steps so that a vehicle wheel having a bright mirror-finished surface is obtained.

Mill scale is left to some extent on this surface. The mill scale must be removed from the design surface. The step of removing mill scale in this embodiment is performed gradually with a grinding machine using abrasive paper having a grit of about #100 to #320. In accordance with the size and shape of the roughness of the design surface, a rotor having the same size may be used instead, or hand polishing may be carried out in addition thereto. The method of removing mill scale is not limited to using abrasive paper, but any other method may be used if it is possible to obtain the same quality finished surface.

Rough finishing is performed on the surface of the vehicle wheel after the step of removing mill scale. This step of rough finishing is performed by so-called dry buffing (i.e, without using any abrasive liquid) through divisional stages, for example, two stages.

The first stage of this rough finishing step is performed at a high rotation speed, for example, of about 2000 rpm by use of a sisal buff and a finishing compound. A sisal buff is a cloth having a strong durable white fiber surface and examples of finishing compounds are Tripoli, Emery Cake, White Rouge, and Jewelers Rouge. These compounds can be obtained from product suppliers such as McMaster-Carr Supply Company.

The second stage of the rough finishing step is performed at the same rotation speed as mentioned above by use of a cotton buff having a smaller rigidity than the above-mentioned sisal buff, and an appropriate finishing compound.

Finally, preliminary and mirror finishing upon the surface of the vehicle wheel is required. Preliminary finishing and mirror finishing are carried out by wet buffing with an abrasive liquid. Eventually, the wheel surface forms a polished or satin machine finish.

A coating is then applied to the polished or satin machine finish on the wheel surface. The coating is preferably a powder coating, but any coating that would adequately protect the aluminum wheel surface finish could be used. Examples of powder coatings include epoxy powders, hybrid powders, polyester-urethane powders, polyester-TGIC powders, polyester amide powders, and acrylic powders. The coating is formed on the surface by a conventional method such as spraying or painting by hand. After the coating is applied to the surface, the coating is heated to about 100° F. to 200° F. for about 10 to 20 minutes by a furnace to be dried and hardened, thereby obtaining a transparent coating.

In addition to the transparent coating having qualities such as high impact and crack resistance, the coating also has ultraviolet light radiation resistance and optical clarity. However, these coatings have a high gloss or surface luster that is unacceptable for some applications. FIG. 2 shows a vehicle wheel having a surface with a high gloss coating. For the purposes of this invention, AN 158C121 clear coating was used for the high gloss coating. As measured with 20° gloss meter, the gloss reading was about 45%. As measured with a 60° gloss meter, the gloss reading was about 63%. Lowering the gloss and maintaining these protective aspects has been a challenge for vehicle wheel manufacturers.

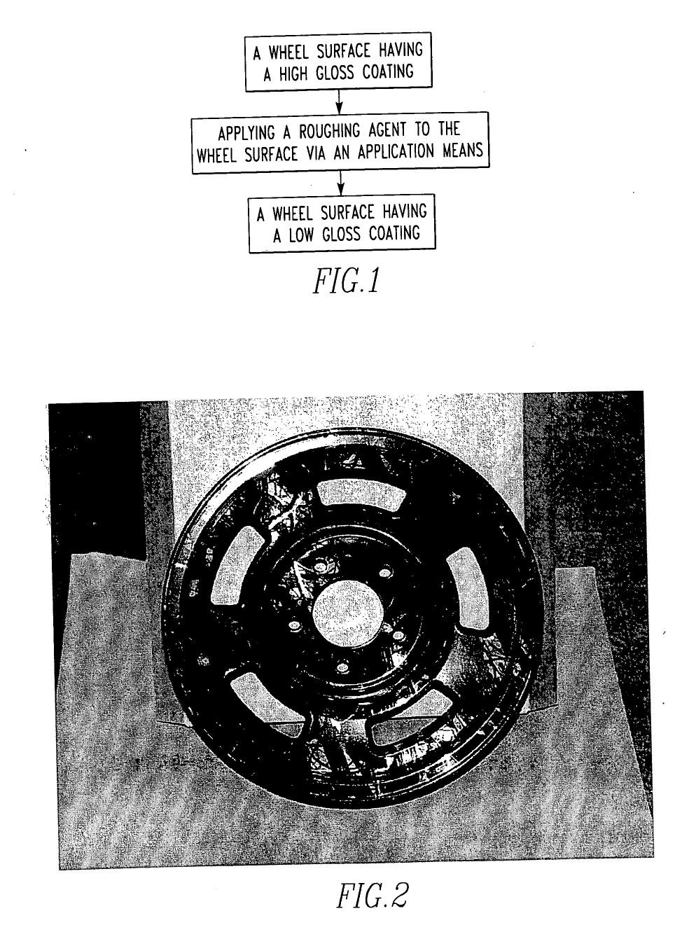

FIG. 1 shows that lowering the gloss of the coating through use of the present invention comprises applying a roughening agent to the coated wheel via an application means. A means such as blasting, preferably grit blasting, is used to apply the roughening agent to the coated wheel surface. However, any means that would roughen the surface of the clear coating could be used.

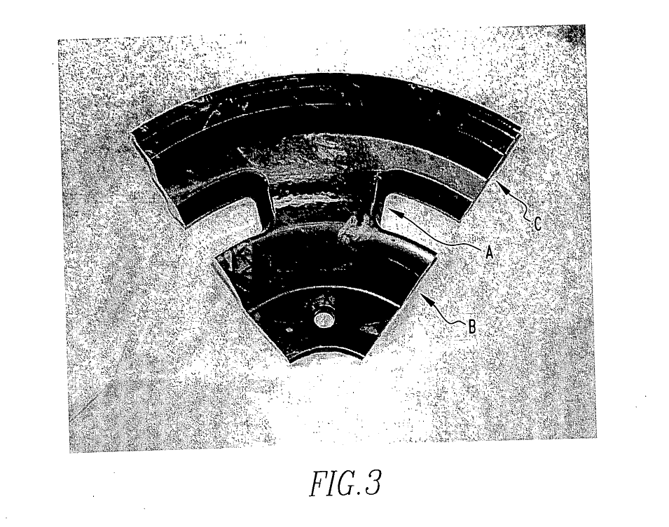

Blasting is a mechanical process by which an abrasive grit such as sand, glass beads, or steel shot is directed under pressure at various materials. The process produces a matte or rough finish of varying degrees depending on the type of media and pressure used. The process of the instant invention comprises grit blasting the coated surface of an aluminum wheel with grit powder, preferably iron or alumina grit, or a plastic media that would roughen the surface of the clear coating. Since these roughening agents have smaller particles that are finer in texture then normal agents, such as glass beads and steel shot, a more appropriate term would be microroughening of the coating surface. This results in retaining the bulk properties of the applied coating, yet producing a much lower gloss level on the surface of the wheel. FIG. 3 shows wheel sections that have two different gloss levels. Section A has a high gloss, while sections B and C, on either side of section A, have lower gloss levels. Sections B and C were subjected to the process of the present invention, namely grit blasting of the wheel surface with a roughening agent. The roughening agent that was applied was about 100 grit iron powder at a pressure of about 30 psi. The grit powder ranges from between about 75 grit to about 150 grit and the pressure at which it is applied ranges from between about 25 psi to about 35 psi. The wheel surface was grit blasted via use of a blasting cabinet, however other types of grit blasting equipment could be used to roughen the wheel surface. As measured with a 20° gloss meter, the gloss reading was about 1.2%. This was about a 97% reduction in gloss from the 20° gloss meter high gloss coating measurement of FIG. 2. As measured with a 60° spectrometer, the gloss reading was about 5.2%, which is about a 92% reduction in gloss from the 60° gloss meter high gloss coating measurement of FIG. 2.

It will be readily appreciated by those skilled in the art that modifications may be made to the invention without departing from the concepts disclosed in the forgoing description. Such modifications are to be considered as included within the following claims unless the claims, by their language, expressly state otherwise. Accordingly, the particular embodiments described in detail herein are illustrative only and are not limiting to the scope of the invention which is to be given the full breadth of the appended claims and any and all equivalents thereof.

1. A process for lowering the gloss of a coating after said coating is applied onto a surface of an article comprising applying a roughening agent to said coating wherein the application of said roughening agent to said coating does not adversely affect the protective properties of said coating.

2. The process of claim 1 wherein said article surface comprises a wheel.

3. The process of claim 2 wherein said wheel comprises metal.

4. The process of claim 3 wherein said metal comprises aluminum.

5. The process of claim 1 wherein said roughening agent comprises grit powder or plastic media.

6. The process of claim 5 wherein said grit powder comprises between about 75 grit and about 150 grit.

7. The process of claim 6 wherein said grit powder comprises about 100 grit.

8. The process of claim 5 wherein said grit powder comprises iron grit powder or alumina grit powder.

9. The process of claim 5 wherein said grit powder comprises iron grit powder.

10. The process of claim 1 wherein said roughening agent is applied to said coated article surface via an application means.

11. The process of claim 10 wherein said application means comprises blasting, spraying, or painting.

12. The process of claim 10 wherein said application means comprises grit blasting.

13. The process of claim 10 wherein said application means applies said roughening agent at a pressure of between about 25 psi and about 35 psi.

14. The process of claim 13 wherein said application means applies said roughening agent at a pressure of about 30 psi.

15. An article having a coated surface, said coated surface being subjected to a roughening agent wherein the application of said roughening agent produces a low gloss on said coated surface while maintaining the protective properties of said coating.

16. The article of claim 15 wherein said article comprises a wheel.

17. The wheel or claim 16 wherein said wheel comprises metal.

18. The wheel of claim 17 wherein said metal comprises aluminum.

19. The wheel of claim 15 wherein said roughening agent comprises grit powder or plastic media,

20. The wheel of claim 19 wherein said grit powder comprises between about 75 grit and 150 grit.

21. The wheel of claim 20 wherein said grit powder comprises about 100 grit.

22. The wheel of claim 19 wherein said grit powder comprises iron grit powder or alumina grit powder.

23. The wheel of claim 19 wherein said grit powder comprises iron grit powder.

24. The article of claim 15 wherein said coated surface is subjected to said roughening agent via an application means.

25. The article of claim 24 wherein said application means comprises blasting, spraying, or painting.

26. The article of claim 24 wherein said application means comprises grit blasting.

27. The article of claim 24 wherein said application means applies said roughening agent at a pressure of between about 25 psi and about 35 psi.

28. The article of claim 27 wherein said application means applies said roughening agent at a pressure of about 30 psi.

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)
